(19) United States
(12) Patent Application Publication
(10) Pub. No.: US 2005/0144026 A1
(43) Pub. Date: Jun. 30, 2005

(54) Methods and apparatus for electronic communication

(76) Inventors: Gary W. Bennett, Scottsdale, AZ (US); Mitchell R. Fisher, Glendale, AZ (US); Matt M. Hall, Scottsdale, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/748,421

(22) Filed: Dec. 30, 2003

(51) Int. Cl. G06F 17/60

(52) U.S. Cl. 705/1

(57) ABSTRACT

Methods and apparatus for electronic communication according to various aspects of the present invention comprise a transaction processing system. The transaction processing system may include one or more translating components for translating transactions into a selected transaction format. The transaction processing system may also include a transaction manager for managing the processing and communication of transactions.

### FIELD OF THE INVENTION

The invention relates to methods and apparatus for communicating and processing data.

### BACKGROUND OF THE INVENTION

Modern processing systems rarely operate as a single, isolated machine in a closed environment. To the contrary, most systems, especially computers operating in large, distributed organizations, are required to operate with other systems. A computer system may operate in a Unix environment, for example, but may communicate with systems running on Microsoft Windows or Apple platforms. Further, the computer system may exchange information with completely different electronic systems, such as interactive voice response systems, telephones, personal digital assistants, and other devices. Some of the other systems may incorporate updated protocols and systems, whereas other legacy systems may operate using outdated technology and software.

Different operating systems, programs with unique input and output characteristics, and other disparities among interacting devices present substantial problems to those trying to make the systems communicate. To make two systems work together, a programmer must typically be familiar with the input and output conventions for both systems. For systems that are configured to communicate with several different devices using an array of different communication protocols, the problem is dramatically compounded.

### SUMMARY OF THE INVENTION

Methods and apparatus for electronic communication according to various aspects of the present invention comprise a transaction processing system. The transaction processing system may include one or more translating components for translating transactions into a selected transaction format. The transaction processing system may also include a transaction manager for managing the processing and communication of transactions.

### BRIEF DESCRIPTION OF THE DRAWING

A more complete understanding of the present invention may be derived by referring to the detailed description when considered in connection with the following illustrative figures. In the following figures, like reference numbers refer to similar elements and steps.

FIG. 1 is a block diagram of a data communication system according to various aspects of the present invention;

FIG. 2 is an illustration of a transaction processing system and a set of external units;

FIG. 3 illustrates an example of a truncation tag;

FIG. 4 illustrates an example of a transaction identifier;

FIG. 5 is a flow diagram of a transaction processing system initiation process; and

FIG. 6 is a flow diagram of a transaction communication and processing process.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional components and various processing steps. Such functional components and processing steps may be realized by any number of components and steps configured to perform the specified functions and achieve the various results. For example, the present invention may employ various elements, communications media, communication formats, computer systems, control systems, databases, interfaces, and the like, which may carry out a variety of functions. In addition, the present invention may be practiced in conjunction with any number of applications, environments, networks, machines, protocols, and languages, and the systems described are merely exemplary applications for the invention. Further, the present invention may employ any number of conventional techniques for manufacturing, assembling, processing, and the like.

A data communications and processing system according to various aspects of the present invention comprises an external unit and a transaction processing system. The external unit and the transaction processing system exchange information in the form of individual sets of information referred to as transactions. For example, the external unit may generate a request transaction, which is received by the transaction processing system. The transaction processing system handles the request and provides a response to the external unit. The request may comprise any appropriate signal or information, such as a request to provide data, process information, store information, initiate an application, and the like. Likewise, the response may comprise any appropriate communication, such as a return of requested data, results of processed data, confirmation of storage of information, a request for data to be processed, and the like. Further, the roles of the systems may be reversed, such that the transaction processing system initiates the request to be handled by the external unit.

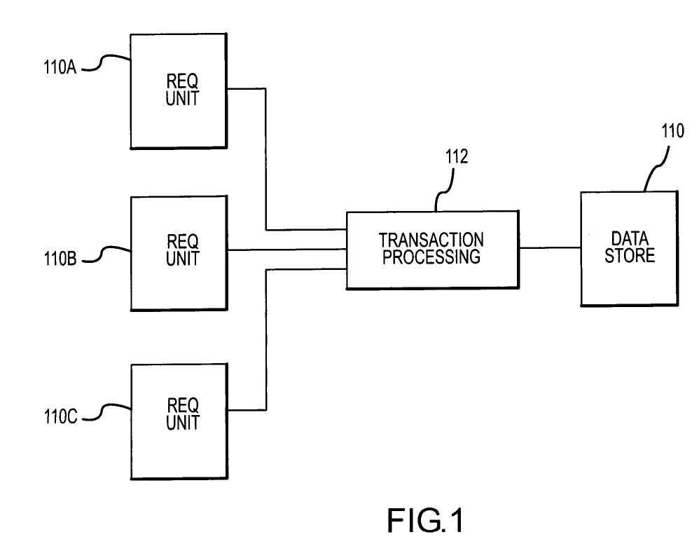

For example, referring to FIG. 1, an exemplary data communications system 100 comprises one or more external units 110 that communicate with a transaction processing system 112. The external units 110 and the transaction processing system 112 may be configured to communicate in any suitable manner and via any appropriate medium, such as a local area network, the Internet, or a direct link. The data communications system 100 may be implemented in any suitable environment, such as an environment that may benefit from a distributed message-based system. For example, various healthcare environments, or other environments that may use distributed implementations, such as warehouse management to control intake, reconciliation, shipping, and the like, or Internet applications, may utilize the data communications system 100.

In particular, the external units 110 are configured to generate and/or receive requests. The external units 110 may comprise any suitable systems for generating and/or receiving the requests, such as a computer system, a handheld device, a telephone, a sensor, a batch reporting system, a data storage system, and the like. In the present embodiment, the external units 110 include multiple devices that generate electronic requests in different formats. For example, one of the external units 110A may comprise a conventional personal computer running applications that request information or computations from the transaction processing system via the Internet using hypertext markup language (HTML). Another external unit 110B suitably comprises a handheld device, such as a personal digital assistant or a cellular telephone, that transmits requests to the transaction processing system 112 via a wireless network. Other external units may include an on-line and batch reporting system 110C and a data storage system 110D. The external units 110 may comprise, however, any suitable systems for providing and/or receiving requests to and from the transaction processing system 112.

The transaction processing system 112 may comprise any suitable system for transmitting data from one point to another. The transaction processing system may be configured to generate and/or handle requests for the external units 110 and, if appropriate, generate responses. For example, the transaction processing system 112 may include one or more servers, mainframe computers, other computers or workstations in a peer-to-peer network, dedicated electronic systems, telephone systems, or other suitable system. In the present embodiment, the transaction processing system 112 includes one or more interconnected servers. The transaction processing system 112 may be configured to receive information from any source on any device, and translate the information according to an appropriate process or program. In the present embodiment, the transaction processing system 112 comprises a system that performs atomic distributed transaction processing based upon a messaging scheme. In one embodiment, the transaction processing system 112 may operate as message-oriented middleware having the ability to queue message requests. The transaction processing system 112 may also operate in conjunction with a service-oriented architecture, and may be deployed in any suitable manner, such as in the form of a web services-based architecture or a grid-based architecture.

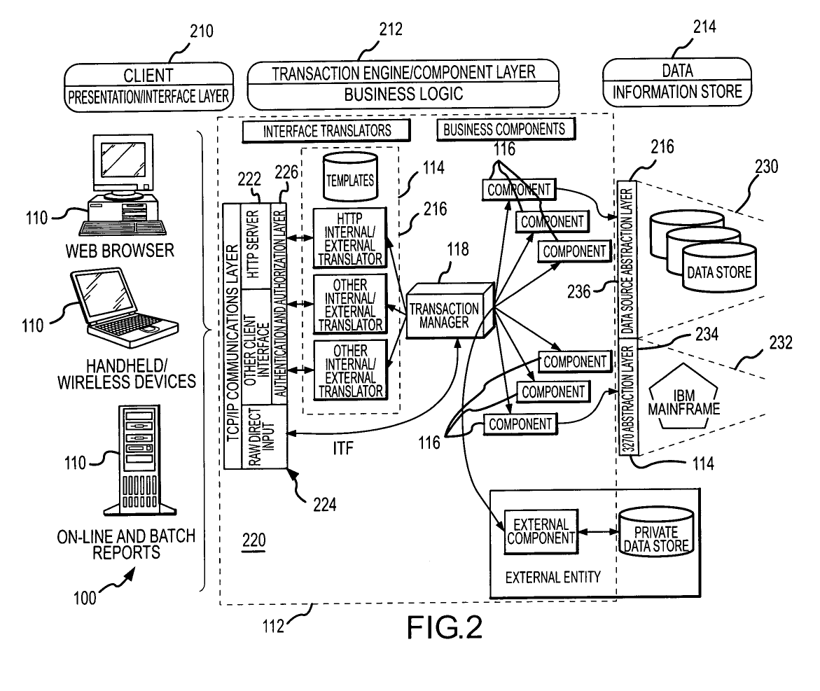

Generally, the present data communication system 100, including the external units 110 and the transaction processing system 112, may be organized in a system of layers. The layers may comprise any appropriate layers, such as layers corresponding to functional aspects of the system, and may comprise any suitable number of layers. For example, referring now to FIG. 2, the data communication system 100 may include a presentation and interface layer 210 and a transaction engine and processing component layer 212. The presentation and interface layer 210 corresponds to systems for presenting information to other systems, such as via the external units 110. The transaction engine and processing component layer 212 translates the information received from the presentation and interface layer 210 for handling and processing. The transaction engine and processing component layer 212 may also process the transaction and/or route the transaction to an appropriate component for processing, and may translate any return communication into an appropriate format for use by the presentation and interface layer 210.

The various layers are suitably configured to be loosely coupled such that each layer operates independently of the other layers. For example, each layer suitably communicates with the other layers using individual transactions in a common data transfer format. Otherwise, the layers may be relatively unrelated. The various layers, such as the presentation layer, component layer, and data layers, can all reside on different host nodes. Consequently, the data communications system 100 may be scaled from a small system to multi-node environments. Further, the loose coupling between the layers and the use of a common transaction format facilitates the use of different types of interfaces into the transaction processing system 112. For example, a system using XML with embedded SOAP instructions or other interface may be interfaced into a transaction management system using the common transaction format.

Other systems or layers may also be included, such as a data storage layer 214. Like the presentation and interface layer 210, the data storage layer 214 and other layers are suitably connected to the transaction engine and processing component layer 212 via translators, such as for translating data between the data storage system format and the format for the transaction engine and processing component layer 212.

Additional sub-layers may be included within the other layers. For example, the transaction engine and processing component layer 212 may include further sub-layers for exchanging information with the external units 110, such as conventional TCP/IP communications layers 220, interface layers 222, and input layers 224. The transaction engine and processing component layer 212 may also include a security layer 226 for controlling access to the transaction processing system 112. The security layer 226 is suitably independent of and transparent to any external component and any applications.

The security layer 226 may control access to the transaction processing system 112 in any suitable manner, such as through user authentication and a data context portal. The user authentication may be performed in any suitable manner, such as via a conventional login and password procedure. The data context portal may be configured to identify a transaction, some context keys, and a validation function that determines whether the user's transaction may be submitted. The security layer 226 may also inhibit users from viewing unauthorized information, such as by placing asterisks or otherwise masking restricted data fields. The security layer 226 may, however, include any appropriate security measures. Other security systems may also be used in addition to or instead of the security layer 226 features.

The transaction engine and processing component layer 212 may also include translation layers 216 for performing the translation between the various formats. The translation layers 216 tend to preserve independence between the various other layers such that different types of systems may interface with the transaction engine and processing component layer 212 via an appropriate translation component. By using the translation layers 216, the various components of the data communication system 100 may interoperate, but do not need to use compatible operating systems or platforms. Consequently, the external units 110 and other systems connected to the transaction processing system 112 may use any suitable operating system, platform, programming language, and/or communication protocol and nonetheless communicate with the transaction processing system 112.

The various layers are implemented by systems and processes in the data communication system 100. In the present embodiment, the translation layers 216 translate data between the various external formats used by systems that communicate with the transaction processing system 112, and a selected transaction format that is used within the transaction processing system. In particular, the present transaction processing system 112 is suitably configured to process data using a selected transaction format for transferring and processing information. To facilitate transfer of information in the selected format, the transaction processing system 112 suitably includes one or more translating components 114 configured to convert data between the selected transaction format and other formats, such as formats used by the various external units 110, data storage systems, or other systems. The transaction processing system 112 may also include one or more processing components 116 for processing requests and/or data. Further, the transaction processing system 112 may include a transaction manager 118 configured to transfer data and commands between the external units 110, the processing components, and other systems.

More particularly, the translating components 114 translate data between the selected transaction format and another format, such as a format that may be used by an external unit 110 or other system. For example, data received from an external unit 110 is provided to a corresponding translating component 114, which operates as an interface between the external unit 110 and the other elements of the transaction processing system 112, such as the transaction manager 118. Conversely, data received from the transaction manager 118 is suitably translated by the translating component 114 from the selected transaction format into a format used by the external unit 110 or other system.

The translating component 114 may be implemented in any suitable manner, such as in software, hardware, firmware, a combination, or other appropriate system. In the present embodiment, the translating components 114 comprise programs executed as an interface between the external unit 110 or other system and the various elements of the transaction processing system 112, such as the transaction manager 118. The translating component 114 is suitably configured to translate between one or more external unit 110 formats, such as HTTP, WML, and/or Palm, and the selected transaction format.

The selected transaction format may comprise any appropriate format for facilitating communication in the transaction processing system 112. The selected transaction format suitably comprises a human-readable format to simplify working with system operations, such as debugging programs. The selected transaction format may also be concise, which tends to minimize data transmission demands. Any appropriate format may be used, however, such as a format utilizing a transaction identifier and a request/return code.

In addition, the selected transaction format is suitably configured to be consistent regardless of the type of transaction. Thus, a transaction's format is the same regardless of whether the transaction is a request or return. Further, the selected transaction format may be interpreted by substantially all eligible elements of the transaction processing system 112, such as the translating components 114, processing components 116, transaction manager 118, and other systems. Because of the uniform transaction format, processing components 116 and transaction managers 118 may reside in one or more interconnected systems, such as systems connected by a network or other communication system. Consequently, processing may be performed on multiple servers and/or machines, each of which may include a dedicated transaction manager 118.

The selected transaction format may be structured in any suitable manner to facilitate handling the transactions. For example, in the present embodiment, the selected transaction format is an internal transaction format utilizing a tag language. The tags may include any appropriate set of tags, such as transaction tags, section tags, template data tags, command tags, and/or other appropriate tags.

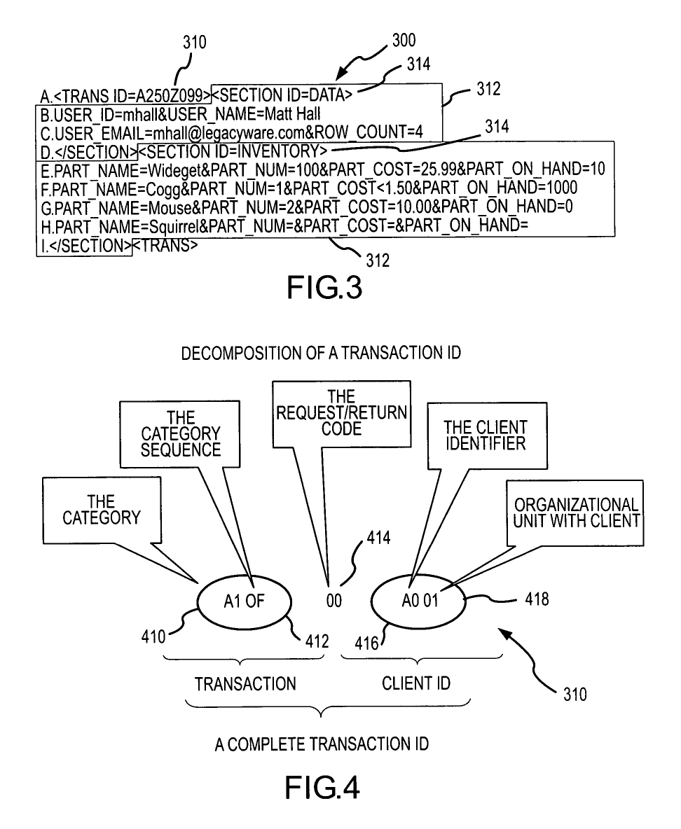

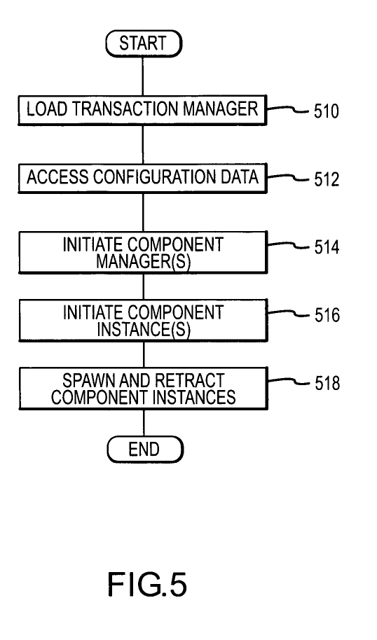

The transaction tag specifies a transaction ID, which suitably corresponds to a particular component 116 and may include other information. Referring to FIG. 3, in the present embodiment, each transaction and component is referenced in a transaction tag 300 using a unique transaction ID 310, such as an alphanumeric designation. The transaction ID 310 suitably uses an inflexible format that must be used for each transaction. For example, referring to FIG. 4, the transaction ID 310 suitably consists of a primary function sequence 410, a secondary function sequence 412, a request/return code 414, a primary client sequence 416, and a secondary client sequence 418. The primary function sequence 410 represents a logical business function or process, and the secondary function sequence 412 represents sub-functions within the primary business function or process. The request/return code 414 is assigned as a result of a call to a processing component 116 via the transaction ID 310. The primary client sequence 416 corresponds to a specific client, and the secondary client sequence 418 is assigned to represent organizations, groups,.or units within the client designated in the primary client sequence. This format facilitates a substantially uniform system for identifying a large number of business functions and components as well as a large number of clients and organization structures within the various clients.

More particularly, the primary function sequence 410 and the secondary function sequence 412 of the present embodiment represent a transaction category and a sub-category. Transaction categories may comprise any grouping appropriate for a particular enterprise, such as different departments like accounts receivable, engineering, or shipping. Similarly, sub-categories may comprise functions or processes within the transaction category, such as tasks or operations performed by the various relevant departments. Thus, each operation described by the transaction category and sub-category may be assigned a unique four-character alphanumeric designation.

The request/return code 414 suitably comprises a value, such as an alphanumeric value, representing an input or return value. The request/return code 414 suitably identifies the request as a request or a type of request, and indicates a return or type of return in response to a request. The request/return code 414 is suitably included in the transaction tag 300 such that each message sent or received within the transaction processing system 112 is stateless, which tends to reduce the overall complexity of the system. Thus, a transaction represents an autonomous request to another part of the system to do a specific task. Each request may result in a response, which may be characterized as positive or negative or according to any other suitable classification.

In the present embodiment, the request/return code 414 is set to a known value, such as 00, for a request, which indicates that the transaction is a request and not a response to a request. Request/return code 414 designations may be assigned to identify various types of returns. For example, various types of positive responses may be assigned values in a range of 01-99 (starting with a numeral), while different types of negative responses may be assigned in a range of A0-ZZ (starting with a letter). Any appropriate system may be used, however, such as a non-printable ASCII character set. Thus, various responses may indicate not only whether a transaction was successful, but may indicate the type of success or failure.

The primary and secondary client sequences 416, 418 suitably comprise alphanumeric designations corresponding to selected classifications, such as a specific client and an organizational unit within a particular client, respectively. For example, each client sequence 416, 418 suitably comprises a two-character alphanumeric designation. For a system dedicated to a single client, the primary client sequence 416 may be identical for all operations. Similarly, the secondary client sequence 418 may be identical for all operations, for example if the administrator does not wish to distinguish between organizational units within the client.

Referring again to FIG. 3, in addition to the transaction ID, the transaction tag 300 may also include additional information, such as data and organizational tags. For example, the transaction tag 300 may include one or more section tags 312 to identify data sections. The section tags 312 may also include section IDs 314 to identify the data in the section tag 312. Any suitable number of section tags 312 may be included in a transaction, each of which is suitably uniquely identified within the transaction. The section tag 312 may include various data, such as one or more name/value pairs or other information that may be relevant to the transaction.

The translating components 114 use the transaction information in the selected transaction format to provide useful data to other systems, such as the external units 110, and translate information from the other systems into the selected transaction format for use by the transaction processing system 112. Referring again to FIG. 2, in the present embodiment, the translating component 114 may translate transaction data into another format by associating a transaction from the transaction processing system 112 with a template, which may be retrieved from memory, such as a template database 228. The association with the proper template may be performed in any suitable manner, such as by using data within the transaction, such as the transaction ID 310. The transaction IDs 310 associated with particular templates for a particular type of translating component 114 may be stored in a configuration file or other file, such as a lookup table. The configuration file may be dedicated to a particular system, such as systems associated with a particular transaction manager 118. The configuration file is suitably stored in shared memory so that the configuration file is accessible to multiple translating components 114, and may be updated without changing the configuration files for individual translating components 114.

The translating components 114 are suitably configured to use the templates to merge transaction data into other formats. The templates suitably include template data tags to extract data from the transaction tag and format the information for use by the external system 110. The template tags may comprise any suitable tags, such as data-only tags for retrieving data, list tags for retrieving listed information, conditional directives for selecting information to be extracted from the transaction or other source file, and any other appropriate tags.

The translating components 114 may further include a system for reformatting data between the selected transaction format and one or more other languages or systems. For example, the present system includes one or more data dictionaries for reformatting information between the selected transaction format and other formats, and thus providing a common interface across all supported platforms. The interface provided by the data dictionary abstracts the selected transaction format from the developer to allow simpler programming by the developer. The data dictionary may be implemented in a variety of languages and platforms. Further, the data dictionary is suitably implemented at a low communication level in the data communications system 100, such as in the communication layer, to facilitate the use of the selected transaction format as a main communication format for transferring information through the data communications system 100.

The data dictionary may be implemented in any suitable manner to reformat data between the selected transaction format and another, second format. For example, the data dictionary may be implemented in conjunction with a set of basic functions for generating, using, and manipulating information in the selected transaction format. In the present embodiment, the basic functions include a PUT function to add entries to a data dictionary container, such as adding an attribute/value pair to a specific section of the transaction. The basic functions may also include a GET function to fetch entries from the data dictionary container, such as to fetch an attribute/value pair from a specific section. In the present embodiment, the GET function is configured to fetch a specific occurrence of an attribute/value pair, in the event that there may be multiple attributes with the same name.

The basic functions may also include a READ function configured to read in a string that contains information in the selected transaction format and import it into the data dictionary container. Conversely, the basic functions may also include a WRITE function for taking contents from the data dictionary container and formatting the contents in the selected transaction format.

The basic functions may also include functions to manipulate attributes in the data dictionary container. For example, the basic functions may include a REMOVE function to remove a specific occurrence of an attribute within a specific function and/or an entire section along with the corresponding attributes. The basic functions may also include a REPLACE function and a RENAME function to replace and rename, respectively, the value of a specific occurrence of an attribute within a specific function. The RENAME function may also be configured to rename a section. In the present embodiment, the RENAME function is configured to preserve the uniqueness of the section name to be changed.

The processing components 116 are systems for generating, receiving, and/or processing data. The processing components 116 may comprise any suitable systems, such as physical machines, programs, processes, or other suitable system. In the present embodiment, the processing components 116 comprise programs, and may comprise any suitable programs. The processing components 116 may be written using any appropriate language, such as, but not limited to, C/C++, Objective-C, Perl, Python, and Java, and are suitably adapted to provide input and output in the selected transaction format. Thus, the processing components 116 may be implemented in multiple different languages within the transaction processing system 112.

Generally, one or more of the processing components 116 are configured to process data received from an external unit 110 or provide data in response to a request from the external unit 110. In the present embodiment, processing components 116 are, like any transaction, called by a unique transaction ID 310. The operation of the components is suitably controlled by the transaction manager 118.

Processing components 116 are suitably referred to according to a component class and a component instance. The component class is the component definition that specifies the operation attributes of the processing component 116. The component instance is the executable that is actually run.

The transaction manager 118 manages one or more of the processing components 116. The transaction manager 118 may comprise any suitable system for transferring data to be transmitted from one point to another and/or managing the processing components, such as a hardware system, a firmware system, a program operating on a server, mainframe, or other machine, a dedicated controller, or other suitable system.

In the present embodiment, the transaction manager 118 comprises a transaction engine configured as a multi-processed or multi-threaded server. The transaction manager 118 may be implemented in a portable language, such as portable C and C++ using STL objects and POSIX system calls. Using a portable configuration provides the ability to be ported from one system to another, such as among Unix systems or Microsoft systems. In addition, the transaction manager may comprise multiple transaction sending and receiving programs. In the event that one of the transaction sending or receiving programs fails, the transaction manager 118 may re-instantiate the program so that the overall load may be handled.

The transaction manager 118 may be configured in any suitable manner to manage the various processing components 116. In particular, the transaction manager 118 may be configurable according to the particular system environment. For example, in the present embodiment, the transaction manager 118 is configured to operate in conjunction with a configuration file containing transaction manager 118 configuration options. The configuration options may include any appropriate information for operating the transaction manager, such as a TCP/IP port number for the transaction manager and a path for locating the transaction manager files. The configuration file may also include information for managing the processing components, such as a starting port number for sequentially designating ports for the processing components 116 as they are initiated, a number of servers or listeners to start, identification information for another transaction manager 118 in the event that the original transaction manager 118 cannot locate a transaction, a maximum number of processing components 116 that may be initiated by the transaction manager 118, and a maximum number of classes of processing components. The configuration information may comprise, however, any appropriate information for configuring the transaction manager 118.

The configuration file may also include any appropriate additional information for the transaction processing system 114. For example, in the present embodiment, the configuration file also includes information relating to the various processing components 116 managed by the transaction manager 118. The configuration file may include a component identifier to match the component to a transaction ID; a routing identifier for forwarding particular transaction IDs to other processing components 116 or other systems; a component name; a path for the executable for the processing component 116; a port number for the processing component 116; a node name for the server on which the processing component 116 resides; a number designating a maximum number of times the transaction manager 118 should restart the processing component 116 in the event of a processing component 116 instance failure; an initial number of instances of the processing component 116 to start and a maximum number of instances 116 to start; a number of processing component 116 instances to initiate whenever volume exceeds the number of operating processing component 116 instances; a retract time corresponding to an amount of time that must elapse before a processing component 116 instance is terminated due to lack of activity; a threshold number of processing component 116 instances that should be available at any given time to process transactions; and/or a timeout value for receiving a response before returning an error. The component configuration information may include, however, any suitable information relating to the processing components 116 managed by or that communicate with or through the transaction manager 118.

The transaction manager 118 may be configured to perform any suitable processes for managing processing components 116 and transactions. In the present embodiment, the transaction manager 118 receives transactions from the various elements of the system, such as the external units 110 and the processing components 116, and routes them to the proper destination. For example, the transaction manager 118 is suitably configured to receive a transaction from an external unit 110 in the selected transaction format and determine an appropriate processing component 116 for processing the transaction according to the information in the transaction tag 300 and in the transaction manager 118 configuration file. The transaction manager 118 is also suitably configured to receive a return transaction from the processing component 116 and send the return transaction to the proper external unit 110.

The transaction manager 118 may be configured to selectively route requests to other nodes, such as other nodes on the Internet or an intranet. In addition, the transaction manager 118 may be configured to refer transactions to other transaction managers, for example if the first transaction manager is too busy to service the transaction. For example, if a particular transaction manager 118 cannot resolve the requested transaction, the transaction manager 118 may refer the request to another transaction manager 118 on a different node. Such routing and referring suitably occurs transparently to any component or tier in the system.

In addition, the transaction manager 118 may be configured to maintain one or more logs to maintain information about the transaction processing system. The parameters for logging, such as nature or amount of information logged and the specific log files, are suitably configurable by the administrator. The transaction manager 118 may use any appropriate system for logging, such as conventional Unix “syslog” logging. The information in the logs may be used for any suitable purpose, such as for optimizing the configuration of the system, testing, recordkeeping, debugging, auditing, failure recovery, and the like. For example, the transaction manager may maintain a transaction log containing a list of all input transactions into the transaction processing system 100. In the event of a failure, the transaction log may be referred to or “replayed” to return the system to its appropriate condition. In the present system, the transaction log may be particularly effective due to the stateless and atomic nature of the transaction processing.

The transaction manager 118 may include various components for managing operations. For example, the transaction manager 118 may include a component manager configured to control the spawning, extension, and retraction of components. In the present embodiment, the transaction manager 118 includes a component manager for each component class that spawns instances. The component manager is suitably configured to monitor the transaction volume and appropriately spawn or retract component instances, such as in accordance with the information in the configuration file. The component manager may also be configured to monitor the operation of the component instances and, in the event a component instance exits or fails, restart the component instance. The component manager may be configured to continue trying to restart the component instance until a particular limit is reached.

The component manager may also be configured to balance the load on the various component instances to provide adequate processing power to process a high volume and reduce the consumption of processing overhead when the transaction volume is lower. In particular, the component manager may be configured to compare the number of available component instances to a spawning threshold and, if the number drops below the spawning threshold, spawn new component instances up to a selected limit. Similarly, if the number of available instances exceeds a retraction threshold or an instance remains inactive beyond a selected period, the component manager suitably terminates the excess component instances, down to a minimum number of instances.

The transaction manager 118 may also include a set of components that remain resident while the transaction manager 118 is operating. The resident components may be referenced in any suitable manner, such as using a transaction identifier 310. The resident components may perform any suitable processes when called, such as terminating the transaction manager 118, providing information relating to the status or operation of components, terminating and restarting components (such as for updating or maintenance), adding components, or adjusting process monitoring parameters.

The transaction processing system 112 may also communicate with other external units 110 or systems in addition to the external units 110, such as storage systems, communication systems, mainframe computers, or other suitable systems. For example, referring to FIG. 2, the additional systems may include a conventional storage system using a conventional database 230 and a remote mainframe 232. Communication between the additional systems and the transaction processing system 112 is facilitated by translating components 114 configured to translate between the selected transaction format and the native formats for the additional systems, such as a 3270 terminal translator 234 for the mainframe 232 and a database translator 236 for the data storage system 230. Systems that operate using the selected transaction format may communicate with the transaction manager 118 without translating components.

A data communications system according to various aspects of the present invention may be adapted for any suitable environment or application, such as remote personnel management, data processing, or records management. For example, referring to FIG. 5, in one embodiment, the data communications system 100 may be configured for a health care system including patient records that may be accessed from multiple locations. When the transaction processing system 112 is initiated, one or more transaction managers 118 may be loaded (510) and each transaction manager 118 may access its configuration file (512). In the present embodiment, the transaction manager 118 initiates multiple transaction sending and receiving programs to provide redundancy in the event of high transaction volume or failure of one or more programs. The transaction manager 118 may then initiate a component manager for each component class to be managed by the transaction manager 118 (514). The component managers may then initiate a selected number of processing component instances (516), such as a number indicated in the configuration file. While the system is operating, each component manager may monitor any relevant parameters, such as the volume of transaction traffic for the relevant component class and idle times for the various component instances. The component manager suitably spawns or retracts component instances in accordance with the relevant parameters and any other suitable criteria, such as the operating attributes specified in the configuration file (518).

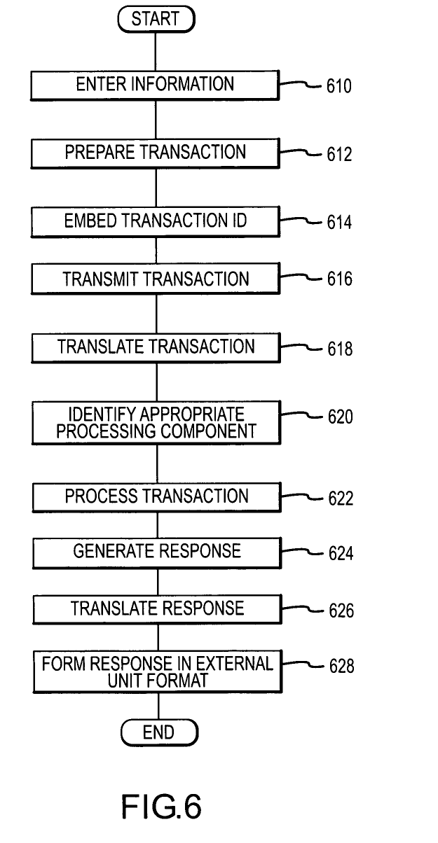

While the transaction processing system 112 is running, an external unit 110 may initiate a transaction. For example, referring for FIG. 6, a health care professional at a remote location may wish to enter information for a new patient, such as the patient's name, contact information, insurance information, and prescribed medications. The health care professional may select any suitable external unit 110, such as a personal computer connected to the transaction processing system 112 via a telephone connection, a cellular telephone connected via a cellular communications link and an interactive voice response system, or a personal digital assistant connected via a wireless network.

The health care professional or other user may enter the relevant information in any suitable manner according to the external unit 110 (610). For example, the user may provide information through a series of data entry fields on a web page. The external unit 110 prepares a transaction in any suitable format (612). In the present embodiment, the external unit embeds a transaction ID as a hidden file in the web-based form (614). The transaction is then transmitted to the transaction processing system 112 (616).

The transaction is received by the transaction processing system 112 and analyzed by the security system. If the transaction is authorized, the translating component 114 interprets the request and identifies the embedded transaction ID. The translation component 114 creates a corresponding transaction in the selected transaction format (618) and forwards the transaction to the transaction manager 118.

The transaction manager 118 receives the transaction and identifies an appropriate processing component 116 for the transaction (620). The truncation manager 118 then forwards the transaction to the processing component 116 for processing. The processing component then processes the request (622). If necessary, the processing component 116 may generate additional transactions to other parts of the transaction processing system or other external units 110, such as to retrieve information from memory. The processing component 116 generates a response in the selected transaction format and sends it to the caller, in this case the transaction manager 118 (624).

The transaction manager 118 receives the response and sends it to the translating component 114. The translating component 114 translates the transaction into a format for use by the relevant external unit 110 (626), such as by pairing the transaction to a selected template, like an HTML template. The data in the response is suitably merged with the template to form a web page or other appropriate communication (628). The translator may then perform any other necessary operations, such as selecting an appropriate MIME type and HTTP header for the response, and sends the resulting communication to the external unit 110. The external unit 110 receives the translated response and conveys it to the user, such as in a visual or audible format.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to an exemplary embodiment. However, changes and modifications may be made to the exemplary embodiment without departing from the scope of the present invention. These and other changes or modifications are intended to be included within the scope of the present invention.

1. A transaction processing system, comprising:
a component layer including at least one processing component configured to process data in a first format; and
a translation layer including a translation component configured to translate data from a second format into the first format.

2. A transaction processing system according to claim 1, wherein the data includes a transaction having a transaction tag.

3. A transaction processing system according to claim 1, wherein the transaction processing system comprises a multi-node environment.

4. A transaction processing system according to claim 3, further comprising a transaction manager, wherein the transaction manager is configured to refer the translated data from a first node to a second node.

5. A transaction processing system according to claim 1, wherein the second format is human readable.

6. A transaction processing system according to claim 1, wherein the component layer includes multiple processing components, and wherein the multiple processing components operate in conjunction with different languages.

7. A transaction processing system according to claim 1, further comprising a transaction manager configured to detect a failure of the processing component and restart the processing component after detecting the failure.

8. A transaction processing system according to claim 1, further comprising a transaction manager configured to:
monitor processing requirements for the processing component; and
at least one of automatically starting and retracting an additional processing component according to the processing requirements.

9. A transaction processing system according to claim 1, wherein the transaction processing system comprises multiple nodes, and the translating component and the processing component are on different nodes.

10. A transaction processing system, comprising:
a translating component configured to receive a transaction in a first format and translate the transaction into a second format;
a processing component configured to process the transaction in the second format; and
a transaction manager configured to transfer the translated transaction to the processing unit.

11. A transaction processing system according to claim 10, wherein the transaction is stateless.

12. A transaction processing system according to claim 10, wherein the transaction includes a transaction tag.

13. A transaction processing system according to claim 10, wherein the transaction processing system comprises a multi-node environment.

14. A transaction processing system according to claim 13, wherein the transaction manager is configured to refer the transaction from a first node to a second node.

15. A transaction processing system according to claim 13, wherein at least two of the translating component, the processing component, and the transaction manager are on different nodes.

16. A transaction processing system according to claim 10, wherein the second format is human readable.

17. A transaction processing system according to claim 10, further comprising multiple processing components, and wherein the multiple processing components operate in conjunction with different languages.

18. A transaction processing system according to claim 10, wherein the transaction manager is configured to detect a failure of the processing component and restart the processing component after detecting the failure.

19. A transaction processing system according to claim 10, wherein the transaction manager is configured to:
monitor processing requirements for the processing component; and
at least one of automatically start and retract an additional processing component according to the processing requirements.

20. A data communications system, comprising:
an external unit configured to communicate data in a first format; and
a transaction processing system configured to communicate with the external unit, including:
a translation component configured to translate the data between the first format and a second format;
a processing component configured to generate and receive data in the second format; and
a transaction manager configured to transfer the data between the translation component and the processing component.

21. A data communications system according to claim 20, wherein the data comprises a stateless transaction.

22. A data communications system according to claim 20, wherein the data includes a transaction tag.

23. A data communications system according to claim 20, wherein the transaction processing system comprises a multi-node environment.

24. A data communications system according to claim 23, wherein the transaction manager is configured to refer the transaction from a first node to a second node.

25. A data communications system according to claim 23, wherein at least two of the translation component, the processing component, and the transaction manager are on different nodes.

26. A data communications system according to claim 20, wherein the second format is human readable.

27. A data communications system according to claim 20, further comprising multiple processing components, and wherein the multiple processing components operate in conjunction with different languages.

28. A data communications system according to claim 20, wherein the transaction manager is configured to detect a failure of the processing component and restart the processing component after detecting the failure.

29. A data communications system according to claim 20, wherein the transaction manager is configured to:
monitor processing requirements for the processing component; and
at least one of automatically start and retract an additional processing component according to the processing requirements.

30. A method of processing data, comprising:
transmitting a request from an external client to a transaction processing system in a first format;
translating the request from the first format to a second format;
transferring the request to a processing component; and
translating a return from the processing component from the second format to the first format.

31. A method of processing data according to claim 30, wherein the request and the return comprise transactions having a transaction tag and data.

32. A method of processing data according to claim 30, wherein the transaction processing system comprises a multi-node environment.

33. A method of processing data according to claim 32, further including referring the request from a first node to a second node.

34. A method of processing data according to claim 30, wherein the second format is human readable.

35. A method of processing data according to claim 30, wherein the request and the return are stateless.

36. A method of processing data according to claim 30, wherein the processing component is one of multiple processing components, and wherein the multiple processing components operate in conjunction with different languages.

37. A method of processing data according to claim 30, further including:
detecting a failure of a process; and
restarting the process after detecting the failure.

38. A method of processing data according to claim 37, wherein the process comprises at least one of a data receiving process, a data sending process, and a processing component.

39. A method of processing data according to claim 30, further including:
monitoring processing requirements for the processing component; and
at least one of automatically starting and retracting an additional processing component according to the processing requirements.

40. A method of processing data according to claim 30, wherein at least one of translating the request, transferring the request, and translating the return, is performed on a different node than at least one of another of translating the request, transferring the request, and translating the return.
